(19) United States
(12) Patent Application Publication
(10) Pub. No.: US 2004/0067703 A1
(43) Pub. Date: Apr. 8, 2004

(54) Electrostatic charge dissipating hard laminate surfaces

(76) Inventors: Bradley L. Grunden, Columbus, OH (US); Daniel E. Badowski, Columbus, OH (US); Kenneth J. Heater, Westerville, OH (US); Salee Gideon, Columbus, OH (US); R. Mark Hodge, Hawthorn (AU)

Correspondence Address: Alan B. Clement, Esq., HEDMAN & COSTIGAN, P.C., 1185 Avenue of the Americas, New York, NY, 10036, US

(21) Appl. No.: 10/676,901

(22) Filed: Oct. 1, 2003

Related U.S. Application Data
(60) Provisional application No. 60/415,833, filed on Oct. 3, 2002.

(51) Int. Cl. B32B 27/04; D04H 1/00; B32B 27/12; D03D 9/00; B32B 5/12

(52) U.S. Cl. 442/33; 442/50; 442/53; 442/57; 442/58; 442/20; 442/31; 442/35; 442/43; 442/44; 442/38

(57) ABSTRACT

The present invention provides improved electrostatic charge dissipating hard laminates by addition of a conductance-modifying component selected from inherently conductive polymers, conductive nanophase materials, or mixtures thereof, to a cellulose-based substrate and thermosetting polymer resin.

### CROSS REFERENCE TO RELATED APPLICATIONS

This application claims priority from U.S. Provisional Application Serial No. 60/415,833, filed Oct. 3, 2002.

### FIELD OF THE INVENTION

The present invention relates to electrostatic charge dissipating materials which, when applied to or incorporated in a substrate material, imparts electrostatic charge dissipating capability. More particularly, the present invention relates to electrostatic charge dissipating hard laminate surfaces or structures suitable for use as worksurfaces for the assembly or testing of electronic components. More particularly, the present invention relates to hard laminate surfaces or structures formed from melamine formaldehyde resins having improved electrostatic charge dissipating properties at low (less than about 10%)relative humidity. Most particularly, the present invention relates to hard laminate surfaces or structures formed from cellulose-based substrate materials treated with melamine formaldehyde resins combined with an effective electrostatic charge dissipating amount of an inherently conductive polymer, a conductive nanophase material, or a combination thereof.

### BACKGROUND OF THE INVENTION

Recent advances in materials and microcircuit architecture and design have resulted in smaller, faster electronic devices, which have become increasingly more sensitive to electrostatic discharge (ESD) events. Uncontrolled electrostatic discharge that occurs between work surfaces and electronic components placed on them can cause damage ranging from complete and immediate component failure, to latent defects that may only manifest themselves a considerable time after the consumer purchases the electronic item. Industry experts have estimated that the actual cost associated with ESD damage to the electronics industry runs into the billions of dollars annually.

To protect sensitive electronic components from electrostatic discharge damage, worksurfaces must be capable of the controlled dissipation of any static potential on materials that contact the surface. In other words, these work surfaces need to be static dissipative, possessing a point-to-point resistance on the order of 10⁶ to 10⁹ ohms when tested in accordance with ESD S4.1, “ESD Association Standard for the Protection of Electrostatic Discharge Susceptible Items—Worksurfaces—Resistance Measurements.”

In recent years, considerable interest has been shown in the development of static dissipative and electrically conductive laminates for use in a variety of applications and environments, including static dissipative work surfaces. Among the prior art patents, there may be mentioned the United States patents to Berbeco, U.S. Pat. Nos. 4,454,199, 4,455,350, 4,589,954, 4,645,717; Grosheim et al., U.S. Pat. No. 4,472,474; Cannady, Jr., U.S. Pat. No. 4,540,624; Ungar et al., U.S. Pat. No. 4,784,908; Wyche et al., U.S. Pat. No. 5,244,721; and O'Dell et al., U.S. Pat. No. 5,275,876. Technical developments in the prior art essentially fall into two categories.

Chemical antistat additives are materials comprised of low molecular weight chemicals such as amides or amines, for example quaternary ammonium compounds. The amides and amines are seldom used alone, but often are combined with ionic salts, such as lithium or sodium chloride. Antistats can be topically coated onto a surface, or can be mixed into a polymer compound in order to create a surface layer on the compound that acts as a charge dissipator. See, e.g., Ungar et al., U.S. Pat. No. 4,784,908; Prasad et al., International Patent Application WO 99/38686. Antistats function by blooming to the surface and attracting enough environmental moisture to create a dissipative surface layer. These compositions frequently rely on the use of a humectant, such as glycerin, to attract moisture. This approach, however, has suffered from multiple drawbacks, most notably dependence on high ambient humidity for functionality. Also, work surfaces using antistat technology for dissipation lack permanence because the antistats easily are rubbed off, resulting in decreased performance over time. The minute particles that are thus “fluffed off” themselves can damage sensitive components, and the presence of these contaminants is a major drawback when the work surface is used in clean room environments. Outgassing of the volatile components can also contaminate the workplace and form layers on component surfaces.

A second solution in the prior art involves the use of filled conductive plastics, which basically comprises a conductive filler added to a thermosetting or thermoplastic resin. See, e.g., Wyche et al., U.S. Pat. No. 5,244,721. These composites are made by filling the thermosetting or thermoplastic resin with conductive particles such as conductive carbon-based materials, stainless steel fibers, silver or aluminum flakes, or metal salts, which serve to create a conductive network within the resin that conducts charges through the composite material. However, because the conductive particles have a relatively high lower limit in their critical effective concentration, this can adversely affect the structural, mechanical or chemical properties of the composite. These qualities of such composites deteriorate as the concentration of filler is increased.

An additional problem seen in the prior art of composite materials is that they have an extremely low tolerance for even slight variations in filler distribution due to the steep loading curve relative to dissipative ability for these fillers. The resulting uneven dissipation of charge leads to “hot spots” on the surface, where charges can congregate and create incidents in which uncontrolled and unpredictable releases of charge can damage or destroy electronic components being manipulated on these surfaces. Composite laminates also often are limited in decorative range, resulting in a non-aesthetic appearance of the work surfaces made from them.

While many of the conventional static dissipative laminates taught in the prior art possess acceptable point-to-point resistance values in the range of 10⁶ to 10⁹ ohms, they do not adequately dissipate charge from items placed upon them when tested in accordance with the procedures outlined in ESD STM4.2, “ESD Association Standard for the Protection of Electrostatic Discharge Susceptible Items—Worksurfaces—Charge Dissipation Characteristics.” ESD STM4.2 describes a method for determining the charge dissipation performance of Type I worksurfaces (e.g., high pressure decorative laminates) at a given relative humidity. Following sample conditioning at the desired relative humidity level for a period of 48 hours, a 6″ aluminum disk of specific mass is charged to a potential of either +1000 V or −1000 V, brought into contact with the surface for a period of 5 seconds and subsequently removed. The amount of charge remaining on the aluminum disk is measured and recorded. A remaining charge of less than |200 V | is considered acceptable.

To date there has been no satisfactory resolution of the problem of charge dissipation on hard work surfaces under conditions of low relative humidity. It is hypothesized that on hard surfaces, the actual interfacial area between the work surface and the component being manipulated is significantly less than the apparent area due to microscopic irregularities on the work surface; these decrease the actual area of contact and result in a considerable reduction of available pathways to ground. Under high humidity conditions, water vapor fills in the spaces between the surface irregularities and provides a conductive fluid path across the interface to ground; but under low humidity conditions, this real decrease in surface area impedes currently available hard work surfaces from adequately dissipating charge.

The prior art of filled conductive plastics does not suggest the use of conductive nanophase materials. In the past these materials suffered from drawbacks associated with dispersion problems due to high degrees of agglomeration, which rendered them unsuitable for use in ESD laminates. However, recent progress made in the area of nanophase particle dispersion has resulted in a number of commercially available conductive nanophase materials pre-dispersed in various media, including aqueous based systems.

Other significant advances made in the prior art involve the use of inherently conductive polymers, or ICPs. See, e.g., Han et al., U.S. Pat. No. 5,254,633. In ICPs, polymers are rendered electrically conductive by one of the processes of oxidation, reduction or protonation (doping), that adds either electrons or protons throughout the volume of the polymer, which then function as the charge-dispersing element. ICPs can be blended into conventional plastics that can be used to form hard work surfaces with high dissipative abilities.

The present invention provides an inherently dissipative polymer composition, which is used to form a hard work surface with sufficient dissipative ability such that the work surface can be safely used to assemble, repair and/or manipulate electronic components upon it, even when used in low humidity (about 0-50% RH) environments. The dissipative polymer composition thus provided is easy to prepare and the laminate can be processed using known commercial methods.

When the dissipative polymer composition is impregnated into a cellulose-based substrate, as found in certain embodiments of the present invention, the cellulose substrate may acquire a slight color tint depending upon the conductive additive employed, enabling it to be applied to a decorative surface sheet or transparent overlay sheet to provide a pleasing work surface. Alternatively, an inherently conductive polymer or conductive nanophase material also may be directly applied to the decorative surface or transparent overlay sheet, for instance by spraying, impregnation or through the use of a transfer coating.

### SUMMARY OF THE INVENTION

In view of the foregoing, it is an object of the present invention to provide a polymer composition, which can be used to form an electrostatic charge dissipating hard surface laminate.

It is also an object of the present invention to provide an electrostatic charge dissipating hard surface laminate, which is not dependent on ambient humidity to function and possesses a point-to-point resistance in the range of 10⁶ to 10⁹ ohms when tested in accordance with ESD S4.1.

It is a further object of the present invention to provide an electrostatic charge dissipating hard surface laminate, which is not dependent on ambient humidity to function and meets all charge dissipation requirements outlined in ESD STM4.2 for a Type I rigid worksurface.

It is yet a further object of the present invention to provide an electrostatic charge dissipating laminate that can be used as a hard work surface upon which one can safely manufacture, assemble, repair or otherwise manipulate sensitive electronic components.

The present invention also provides a laminated hard work surface comprising a combination of a thermosetting formaldehyde polymer resin, an inherently conductive polymer and a cellulose-based material.

It is a still further object of the present invention to provide a hard laminated work surface comprising a combination of a thermosetting formaldehyde resin, a conductive nanophase material and a cellulose based material.

It is a further object of the invention to provide an intrinsically dissipative polymer compound, which is water dispersible and contains no volatile organic compounds.

It is yet a further object of the present invention to provide a transfer coating comprised of a thermosetting vinyl resin, a conductive nanophase material, an inherently conductive polymer or combination thereof.

It is a further object of the present invention to provide a polymer composition for forming electrostatic charge dissipating hard surface laminates, which can be easily processed.

It is a further object of the present invention to provide a polymer composition that comprises a thermosetting polymer resin in combination with an inherently conductive polymer, a conductive nanophase material or both.

The present invention also provides a method of forming an electrostatic charge dissipating hard laminate surface comprising impregnating a cellulose-based substrate with an aqueous dispersion of a thermosetting formaldehyde polymer resin in combination with an inherently conductive polymer, such as polyethylene dioxythiophene polystyrene sulfonate and curing said impregnated cellulose-based material.

The present invention additionally provides a method of forming an electrostatic charge dissipating hard laminate surface by preparing an aqueous dispersion of an inherently conductive polymer, conductive nanophase particles or a combination thereof, and spraying the dispersion, such as with, but not limited to, an aerosol system, onto the surface of a cellulose-based material, which has previously been impregnated with a thermosetting formaldehyde polymer resin.

The present invention additionally provides a method of forming an electrostatic charge dissipating hard laminate surface by preparing an aqueous dispersion of an inherently conductive polymer, conductive nanophase particles or a combination thereof, and impregnating the dispersion into a cellulose-based substrate material, which is subsequently impregnated with a thermosetting formaldehyde polymer resin.

The present invention further provides a method of forming an electrostatic charge dissipating hard laminate surface by transferring a curable thermosetting vinyl resin-based transfer coating comprising a dissipative polymer composition, which comprises an inherently conductive polymer and/or a conductive nanophase material, onto the surface of a melamine formaldehyde treated cellulose based material during the cure process.

It is another object of the present invention to provide a workstation or tabletop comprised of the hard work surface laminates of the present invention.

These and other objects are provided by the present invention, which provides a polymer composition comprising a thermosetting polymer resin in combination with an inherently conductive polymer, a conductive nanophase material or a combination thereof for the preparation of electrostatic charge dissipative hard laminate work surfaces capable of performing at low relative humidities (0-50%).

### DETAILED DESCRIPTION OF THE INVENTION

The invention provides an inherently conductive polymer composition, which may be used in forming an electrostatic charge dissipating laminate. The resulting laminate is not dependent on ambient humidity for functionality and so is an excellent hard-surface material for use in workstation tabletops where these qualities are desired.

The first component of the composition of the present invention comprises the electrically conductive modifying component, which may comprise an inherently conductive polymer, an electrically conductive nanophase material or a combination thereof.

Inherently conductive polymers used in the present invention include any organic polymer that may be rendered electrically conductive via one of the processes of oxidation, reduction or protonation (doping), that adds either electrons or protons throughout the volume of the polymer, which then function as the charge dispersing element. Non-limiting examples are polyethylene dioxythiophene polystyrene sulfonate (PEDOT/PSS), polyaniline (PANI), polypyrrole (PPy), poly(phenylene vinylene) and mixtures thereof. For the purposes of the present invention, it is preferred to use PEDOT/PSS, PANI or combinations thereof as the inherently conductive polymer additive due to their availability as dispersions in aqueous media.

PEDOT/PSS may be prepared by methods known to those of ordinary skill in the art. See, e.g. U.S. Pat. Nos. 5,221,786; 4,986,886; 5,137,799; 5,158,707; 5,405,937 and European Patent Nos. 0375005; 0408105 and 0473224. PEDOT/PSS is also commercially available, for example from Bayer Corporation under the trade designation Baytron® P. Baytron® P is an aqueous dispersion of PEDOT/PSS. See Bayer Product Information sheet AI4071 dated April 1995. PEDOT/PSS has the following general structure:

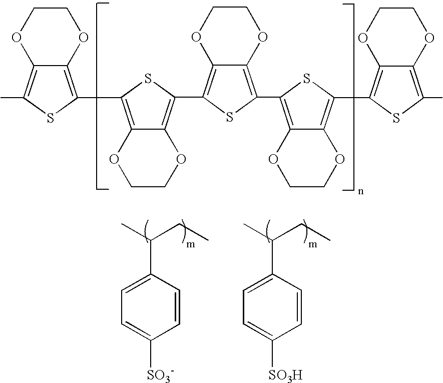

wherein n and m independently can range from 2 to 1000 or more.

Polyaniline also may be prepared by those possessing ordinary skill in the art. See, e.g. U.S. Pat. Nos. 6,265,532; 6,194,540; 5,993,694; 5,891,970; 5,792,830; 5,641,859; 5,540,862; 5,520,852; 5,324,453. PANI is commercially available from Zipperling Kessler & Company under the trade designation ORMECON® and from Panipol Limited under the trade designation Panipol®. Panipol® W is preferred due to the fact that it has a relatively high concentration (approximately 8% by weight) of conductive polyaniline dispersed in an aqueous medium. PANI has the following general chemical structure:

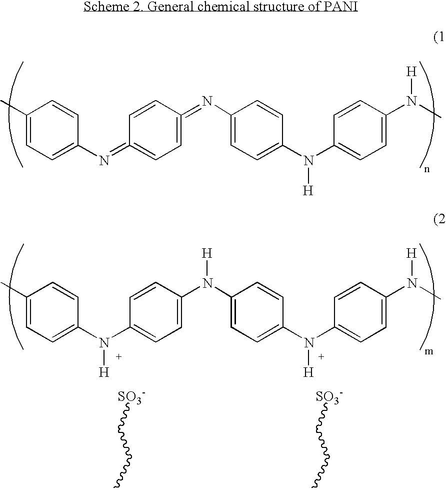

wherein n and m independently can range from 2 to 1000 or more.

The electrically conductive nanophase materials useful in the practice of the present invention include any nanophase materials that are electrically conductive. Non-limiting examples are antimony tin oxide, fluorine-doped zinc oxide, carbon based materials and mixtures thereof. The preferred conductive nanophase material of the present invention is antimony tin oxide. Antimony tin oxide nanophase materials are commercially available, for example from Nanophase Technologies, Burr Ridge, Ill.

The second component of the composition of the present invention comprises a polymeric resin, either thermoplastic or thermosetting, to be combined with the inherently conductive polymer, the conductive nanophase materials or mixtures thereof.

The thermosetting resins to be included in the present invention are curable or crosslinkable resins or polymers, such as unsaturated polyesters, polyurethanes, polyureas, epoxies and bismaleimides, but generally are formaldehyde-type thermosetting resin compositions, such as melamine formaldehyde, urea formaldehyde, phenol formaldehyde and other methylol-type resins that are subject to curing under heat in the presence of a catalyst. Preferred are melamine formaldehyde resins due to the physical properties imparted to the laminate by these resins, as well as the tendency of these systems to form clear coatings. These types of resins are well known to those of ordinary skill in the art and are available commercially from a variety of sources.

In curing of conventional curable or crosslinkable resins a catalyst is typically added. Generally the catalyst varies in amount and composition but is typically comprised of p-toluenesulfonic acid or Lewis acid-type catalysts, particularly Lewis acid metal salt catalysts, such as aluminum trichloride, boron trifluoride, or multivalent metallic salt halides or sulfates, such as magnesium chloride or zinc sulfate.

Although conventional catalysts may be employed in the practice of the present invention, unexpectedly the present inventors have found that the inherently conductive polymers and/or the electrically conductive nanophase materials, in addition to providing the improved electrostatic charge dissipating properties, also can function as a curing catalyst for the thermosetting resin. Thus, in many instances, no additional catalyst is required.

Thermoplastic substrate materials also may be included in the present invention and encompass a wide range of resin systems, including but not limited to polyolefins, polyurethanes, polyesters, acrylics, polyacetals, polyamides, polyaryl ethers, polyimides, polyketones and vinyl polymers. These types of resins are well known to those ordinarily skilled in the art and are available commercially from a variety of sources.

To form the inherently conductive polymer composition in one embodiment of the present invention, polyethylene dioxythiophene polystyrene sulfonate, polyaniline or mixtures thereof are combined in amounts ranging from 15% to under 1% by weight based on total melamine formaldehyde resin solids, preferably 1-5%, in an aqueous dispersion with the thermosetting polymer resin, such as by using high shear mixing to ensure a complete and evenly dispersed mixture. The resin composition thus formed is then used to impregnate a cellulose-based material, such as alpha-cellulose paper, by methods generally known in the art. The cellulose-based material may be a transparent overlay sheet, a decorative surface sheet or both, depending upon final laminate preparations. A preferred embodiment envisions that the weight of the resin composition ranges from about 20% to about 75%, preferably from about 45% to about 65%, of the total weight of the treated alpha-cellulose paper sheet, depending upon the type and basis weight of the paper treated.

The cellulose-based material used in the present embodiment may be pre-treated with a colloidal dispersion of an inherently conductive polymer, a conductive nanophase material or a mixture thereof in aqueous media prior to impregnation with the thermosetting resin composition in order to decrease the volume resistance of the cellulose-based material from about 10⁷ ohms to the more desirable range of approximately 10⁴-10⁶ ohms when tested in accordance with ESD S4.1.

Concentration ranges of conductive materials in the colloidal dispersion vary depending upon the system employed. Generally speaking, inherently conductive polymers can be used at concentrations ranging from 0.1% to 20.0% by weight, preferably 0.25% to 10.0%, and most preferably 0.5% to 2.5%. Conductive nanophase materials can be used at a concentration range of 1% to 25% by weight, preferably 2.5% to 10%. Pre-treatment of the cellulose-based materials may be affected using methods similar to those for impregnating cellulose-based materials with melamine formaldehyde resin, i.e., dip and squeeze technique, reverse roll coat, etc. The colloidal dispersion of conductive materials is applied at rate ranging from 0.005 g/cm² to 0.045 g/cm². Following pre-treatment with the colloidal dispersion of ICP, conductive nanophase material or mixture thereof, the cellulose-based substrate or paper is dried at a suitable temperature prior to impregnation with the thermosetting resin composition.

After being impregnated with the ICP and/or nanophase modified melamine formaldehyde resin, the impregnated cellulose material is dried at a suitable temperature prior to use as a laminate. ICP modified melamine formaldehyde resin treated cellulose-based materials possess only a slight tint compared to melamine formaldehyde treated materials, still allowing for an aesthetically pleasing appearance of the hard work surface laminate where desired.

A laminate is formed comprised of the ICP and/or nanophase material modified melamine formaldehyde treated cellulose-based material, either a transparent overlay sheet, a decorative under sheet or both, and one or more cellulose-based sheet materials that have been saturated with a thermosetting polymer resin, the number of layers varying according to the grade or thickness of laminate desired. Following standard methods of high pressure decorative laminate manufacture, one or more layers comprised of a heavy paper, such as Kraft paper, which may be saturated with a phenol formaldehyde resin, can be incorporated into the laminate to provide a sturdier product and to avoid reflection of defects from the solid substrate to the work surface to which the laminate is attached.

A conductive scrim layer optionally may be incorporated into the laminate. The conductive scrim layer may consist of a coating of an inherently conductive polymer, a conductive nanophase material or mixtures thereof deposited onto the back side of a transparent overlay sheet, a decorative surface sheet or any other suitable sheet included in the assembly of the laminate. The conductive scrim layer alternately may be composed of a conductive non-woven material, such as carbon fibers or nickel coated carbon fibers, which is incorporated into the laminate beneath the ICP modified melamine formaldehyde treated surface sheet(s). Optionally, the conductive scrim layer subsequently may be treated with a melamine formaldehyde resin and dried prior to incorporation into the laminate build-up to enhance adhesion and consolidation into a solid laminate product.

The desired quantity of resin saturated sheets are assembled, then pressed and cured and formed into a laminate structure using standard production procedures of conventional laminates for use as work surfaces, walls and flooring. The laminates of the present invention can be produced on conventional high pressure decorative laminate production lines and do not require investing in the development of unusual or difficult production parameters, thus giving the invention the benefit of having a simple production process.

Recent advances in materials processing technology allow precursor materials to be milled down to nanophase powders, which can be used in the production of high efficiency integrated conductive resin systems. In applications such as ESD work surfaces, where interfacial properties and inter-particle spacing are important, the present inventors have found that properly dispersed nanophase materials provide the ability to achieve a significantly enhanced surface area to volume ratio, and also offer the ability to achieve a high level of powder dispersion at relatively low loading levels. Surface to area ratios in nanophase materials are 3 to 4 orders of magnitude greater than those inherent to micro-phase materials, and provide corresponding improvements in efficiency of interface-critical processes that allow particle loading at beneficially lower levels.

In another embodiment of the present invention, the electrostatic dissipative polymer composition is comprised of conductive nanophase materials, such as antimony tin oxide, fluorine-doped zinc oxide, conductive carbon based materials or mixtures thereof combined in amounts ranging from under 1% to 25% by weight based on total melamine formaldehyde resin solids, preferably 1-15%, and most preferably 2.5-10% in an aqueous dispersion with the thermosetting polymer resin such as by using high shear mixing to ensure a complete and evenly dispersed mixture. The resin composition then is used to impregnate a cellulose-based material, such as alpha-cellulose paper in the usual way. The cellulose-based material may be a transparent overlay sheet, a decorative surface sheet, or both, depending upon final laminate preparations. A preferred embodiment envisions that the weight of the resin composition ranges from about 20% to about 75%, preferably from about 45% to 65%, of the total weight of the treated alpha-cellulose paper sheet, depending upon the type and basis weight of the paper treated.

The cellulose-based material used in the present embodiment also may be pre-treated with a colloidal dispersion of an inherently conductive polymer, a conductive nanophase material, or a mixture thereof in aqueous media prior to impregnation with the thermosetting resin composition. Concentration ranges of conductive materials in the colloidal dispersion vary depending upon the system employed. Generally speaking, inherently conductive polymers can be used at concentrations ranging from 0.1% to 20.0% by weight, preferably 0.25% to 10.0%, and most preferably 0.5% to 2.5%. Conductive nanophase materials can be used at a concentration range of 1% to 25% by weight, preferably 2.5% to 10%. Pre-treatment of the cellulose-based materials may be effected using similar methods for impregnating cellulose-based materials with melamine formaldehyde resin, i.e. dip and squeeze technique, reverse roll coat, etc. The colloidal dispersion of conductive materials is applied at rate ranging from 0.005 g/cm² to 0.045 g/cm². Following pre-treatment with the colloidal dispersion of ICP, conductive nanophase material, or mixture thereof, the paper is dried at a suitable temperature.

Compilation of the laminate follows in a similar manner as that described in the previous embodiment. A laminate is formed comprised of the conductive nanophase modified melamine formaldehyde treated cellulose-based material (either a transparent overlay sheet, a decorative under sheet or both), one or more cellulose-based sheet materials, which have been saturated with a thermosetting polymer resin, and an optional conductive scrim layer. Standard methods of high-pressure decorative laminate manufacture are employed to consolidate the treated components into the final laminate structure.

In yet another embodiment of the present invention, the inherently conductive polymer composition is achieved by simply impregnating a cellulose-based substrate with a colloidal dispersion of an inherently conductive polymer, conductive nanophase material or mixtures thereof in water followed by impregnation of the cellulose-based material with conventional melamine formaldehyde resin. Impregnation of both aqueous mixtures can be effected using methods commonly employed to those familiar with the art, such as conventional dip and squeeze techniques, reverse roll coating, etc. In another embodiment of the present invention, in addition to inclusion of the ICP or nanophase materials of the present invention, it is further contemplated by the present invention that conventional additives also may be added by conventional addition methods.

The amount of conductive additive in the aqueous colloidal dispersion, either ICP-based, conductive nanophase-based or mixtures thereof may range from about 0.1 to about 15.0 wt. %, depending upon the type of additive employed. ICP-based colloidal dispersions preferably are used in concentrations ranging from about 0.5 to about 2.0 wt %, while the conductive nanophase materials preferably are used in concentrations ranging from 2.5 to 10.0 wt. %. The application rate of the conductive additive colloidal dispersion can range from 0.0005 g/cm² to 0.1000 g/cm², preferably in the range of 0.0010 g/cm² to 0.0500 g/cm², and most preferably in the range of 0.0025 g/cm² to 0.0250 g/cm². Following treatment of the cellulose-based material with the colloidal dispersion of ICP, conductive nanophase material, or mixture thereof, the paper is preferably dried at a suitable temperature prior to application of the melamine formaldehyde resin.

Once the cellulose substrate is treated with the inherently conductive colloidal dispersion, conventional melamine formaldehyde resin is used to impregnate the substrate material in the usual way. The cellulose-based material may be a transparent overlay sheet, a decorative surface sheet, or both, depending upon final laminate preparations. A preferred embodiment envisions that the weight of the resin composition ranges from about 20% to about 75%, preferably from about 45% to 65%, of the total weight of the treated alpha-cellulose paper sheet, depending upon the type and basis weight of the paper treated.

Compilation of the laminate follows in a similar manner as that described in the previous embodiments. A laminate is formed comprised of the conductive additive modified melamine formaldehyde treated cellulose-based material (either a transparent overlay sheet, a decorative under sheet or both), one or more cellulose-based sheet materials that have been saturated with a thermosetting polymer resin and an optional conductive scrim layer. Standard methods of high-pressure decorative laminate manufacture are employed to consolidate the treated components into the final laminate structure.

In yet another embodiment of the present invention, a colloidal dispersion of an inherently conductive polymer, conductive nanophase material, or mixtures thereof in water may be applied onto the surface of a cellulose-based material that previously had been impregnated with a melamine formaldehyde resin via a spraying process or by using a more conventional dip and squeeze technique and then is dried. Application may be effected either before or after drying of the previously impregnated cellulose-based material. The amount of conductive additive in the aqueous colloidal dispersion, either ICP-based, conductive nanophase based, or mixtures thereof may range from about 0.1 to about 15.0 wt. %, depending upon the type of additive employed. ICP-based colloidal dispersions are preferably used in concentrations ranging from about 0.5 to about 2.0 wt %, while the conductive nanophase materials are preferably used in concentrations ranging from 2.5 to 10.0 wt. %. Spraying may be effected by any means known to those skilled in the art, but preferably an aerosol spray is employed. The application rate of the conductive additive colloidal dispersion can range from 0.0005 g/cm² to 0.1000 g/cm², preferably in the range of 0.0010 g/cm² to 0.0500 g/cm², and most preferably in the range of 0.0025 g/cm² to 0.0250 g/cm².

In embodiments using the direct application of a conductive colloidal dispersion via aerosol spraying or the more conventional dip and squeeze technique, the material may be applied onto a transparent overlay sheet, decorative surface sheet, or both which will form the top layer of the laminate, thus giving a pleasing appearance to the laminate. Compilation of the final laminate structure and preparation of the high-pressure decorative laminate then follows the practices outlined in the aforementioned embodiments.

In yet a further embodiment of the present invention, the inherently dissipative polymer composition may be comprised of an inherently conductive polymer, a conductive nanophase material, or mixture thereof combined with a UV-curable thermosetting polymer resin to form a transfer coating which when cured in conjunction with a standard high-pressure decorative laminate build-up forms an electrostatic charge dissipative laminate surface. Examples of the thermosetting polymer resins which may be used in the present embodiment include unsaturated polyesters, vinyl esters, polyurethanes, polyureas, epoxies, and bismaleimides, the preferred being unsaturated polyester resins due to their tendency to form clear coatings and relative ease of processing. The unsaturated polyester resins used in the present embodiment may include general purpose ortho(phthalic) resins, isophthalic resins, phthalic resins, chlorendic resins and others diluted with copolymerizable monomers such as styrene, vinyl toluene, methyl methacrylate, or other vinyl containing reactive monomers.

The transfer coating is formed by coating a melamine-acrylic based release paper of the sort known to those skilled in the art (see e.g., Toomey, U.S. Pat. No. 5,958,595 and Power, et al., U.S. Pat. No. 4,118,541) with an unsaturated polyester resin comprised of initiating compounds, an inherently conductive polymer, a conductive nanophase material or mixtures thereof.

The initiating compounds of the present embodiment include photoinitiators and thermal initiators capable of affecting both the partial cure, e.g., B-staging, and complete cure of the unsaturated polyester resin. Photoinitiators of the present embodiment include aliphatic and aromatic ketones, such as benzophenone and acetophenone, as well as benzoin, benzoin ethers, benzil, benzil ketals and other related compounds. Thermal initiators of the present embodiment include any compound capable of undergoing thermal, homolytic dissociation at elevated temperatures. However, in general, the commercial availability of these compounds is primarily limited to peroxide compounds, such as acetyl peroxide, benzoyl peroxide, cumyl peroxide, t-butyl peroxide, cumyl hydroperoxide, t-butyl hydroperoxide, t-butyl perbenzoate, acyl alkylsulfonyl peroxides, dialkyl peroxydicarbonates, diperoxyketals, and ketone peroxides. One other class of compounds of commercial significance are azo compounds, e.g., 2,2′-Azobisisobutyronitrile (AIBN).

In the method of making the transfer coating of the present invention, about 0.1 wt % to 25 wt. % of an inherently conductive polymer, a conductive nanophase material or mixtures thereof are mixed into a styrenated, unsaturated polyester resin containing approximately 0.05 wt. % to 10 wt. % of a photoinitiator compound and from about 0.05 wt. % to 10 wt. % of a thermal initiator, to provide a homogeneous composition having electrically conductive moieties uniformly dispersed therethrough. The composition is then applied to a melamine-acrylic based release paper as a 0.05 mil to 100 mil thick coating and B-staged, e.g., dried but still capable of further cure, by exposure to ultraviolet radiation.

The B-staged, inherently dissipative, unsaturated polyester resin coated release paper can then be placed on additional stack-up layers, such as phenolic coated Kraft papers, an optional barrier layer, an optional conductive scrim layer, and a decorative surface sheet and consolidated into a laminate using conventional high-pressure decorative laminate manufacturing processes.

In the case of thermoplastic substrates the conductive additives may be added to the thermoplastic substrate materials using a variety of methods, such as high shear mixing, advanced dispersion and blending techniques, and in some cases via the direct in-situ polymerization of the conductive polymer in an appropriate matrix material. The thermoplastic/conductive polymer material mixture may then be processed using conventional thermoplastic techniques, such as resin transfer molding, extrusion, injection molding, etc., to form a humidity independent, electrostatic dissipative resin composition.

### DESCRIPTION OF THE PREFERRED EMBODIMENTS

The following examples are provided for illustrative purposes only and are not to be construed to limit the scope of the claims in any manner whatsoever.

Sample laminates and constituents thereof described above in the preferred embodiments were characterized in accordance with appropriate standards published by the Electrostatic Discharge Association. The relevant ESD Association Standards included the following:

1. Point-to-point resistance using ESD S4.1-1997, “ESD Association Standard for the Protection of Electrostatic Discharge Susceptible Items—Worksurfaces—Resistance Measurements.” The point-to-point resistance (Rₜₜ) of the materials was measured using two ETS 850 probes placed 6 inches apart on center and recorded after 15 seconds of contact at a charge level of 100 V.

2. Electrostatic charge dissipation using ANSI/ESD STM4.2-1998, “ESD Association Standard for the Protection of Electrostatic Discharge Susceptible Items—Worksurfaces—Charge Dissipation Characteristics.” The charge remaining on an aluminum charge plate, decaying from an initial electric potential of ±1000 V, was determined after removing the plate following 5 seconds of contact with the ESD surface. An acceptable level of charge remaining on the disk is less than |200 V|.

### EXAMPLE 1

Control laminates were prepared and tested for static dissipative properties at different levels of relative humidity. To reduce warpage, symmetrical laminate buildups were employed. The control laminates were made using two solid decorative surface sheets saturated with an aqueous solution of melamine formaldehyde resin to approximately 50-55% resin content. The core of the laminates comprised four phenol-formaldehyde impregnated Kraft papers sandwiched between two phenol-formaldehyde impregnated barrier sheets.

The control laminates were pressed at 270-280° F. under a pressure of 450-500 psi in a multi-opening press for about 45-60 minutes. The laminates were then mounted to ⅝″ plywood using contact adhesive and wood screws. Laminates of the current example were designated EX-1A and EX-1B. The laminates were subsequently tested for surface resistance (point-to-point, Rₜₜ) and electrostatic charge dissipation at 50% RH and 10% RH. The results of the electrical testing are summarized in Table 1.

TABLE 1

| | Relative | Resistance | Charge Dissipation - Residual | |
|---|---|---|---|---|
| Laminate | Humidity | (Point-to-Point) | Charge on Disk (Volts) | |
| ID | Level | (Ohms) | +1000 V | −1000 V |
| EX-1A | 50% RH | 3.62 × 10¹⁰ | 988 | −984 |
| | 10% RH | 3.98 × 10¹⁰ | 989 | −993 |
| EX-1B | 50% RH | 3.89 × 10¹⁰ | 978 | −991 |
| | 10% RH | 3.56 × 10¹⁰ | 990 | −980 |

Based on the results presented in Table 1, it is evident that none of the control laminates are suitable for use as static dissipative work surfaces at the relative humidities tested as both laminates possessed point-to-point resistances outside the static dissipative range of 10⁶ to 10⁹ ohms. As a result, neither laminate adequately dissipated electrostatic charge from its surface at either applied potential as can be seen from the charge dissipation test results.

### EXAMPLE 2

An inherently conductive polymer (ICP) composition was prepared by blending 1.0 wt. % Baytron® P (source: Bayer Corporation), based on solids, with a 52% solids, uncatalyzed aqueous melamine formaldehyde resin using high shear mixing to ensure a complete and evenly dispersed mixture. The ICP modified melamine formaldehyde resin then was used to saturate or impregnate a sheet of transparent overlay material, using techniques commonly employed in the high-pressure decorative laminate industry. Due to the lowered melamine formaldehyde resin solids resulting from the addition of the Baytron® P product, a second coating step was employed to increase the total resin content of the treated paper. The total resin content of the dried treated transparent overlay material was approximately 65%.

A sample laminate was prepared with identical core materials and decorative surface sheets used in Example 1, plus the addition of the polyethylene dioxythiophene/melamine formaldehyde resin treated transparent overlay sheet comprising the outermost or surface layer of the laminate, denoted EX-2. Cure of the laminate was affected by pressing the laminate in a multi-opening press at 270-280° F. under a pressure of 1200-1400 psi for approximately 45-60 minutes.

The sample laminate of Example 2 hereinabove denoted EX-2 was mounted on ⅝″ furniture grade plywood, isolated from ground, and tested for point-to-point resistance (Rₜₜ), and electrostatic charge dissipation at 50% and 10% relative humidity, respectively. Results of the electrical testing performed on EX-2 are shown in Table 2.

TABLE 2

| | Relative | Resistance | Charge Dissipation - Residual | |
|---|---|---|---|---|
| Laminate | Humidity | (Point-to-Point) | Charge on Disk (Volts) | |
| ID | Level | (Ohms) | +1000 V | −1000 V |
| EX-2 | 50% RH | 1.30 × 10⁶ | 33 | −1 |
| | 10% RH | 1.71 × 10⁶ | 19 | −11 |

Incorporation of the polyethylene dioxythiophene into the surface layer of the laminate effectively decreased the point-to-point resistance of the resulting laminate from approximately 10¹⁰ ohms to approximately 10⁶ ohms, thereby creating a laminate with static dissipative properties as defined by surface resistance. Results from the charge dissipation testing also showed a dramatic decrease in the amount of residual charge remaining on the aluminum charge plate, going from approximately |986 V | to about |17 V| at 50% RH and from approximately |991 V| V to |15 V| at 10% RH indicating that the laminate adequately dissipated all charge in contact with the laminate surface.

### EXAMPLE 3

A second inherently conductive polymer composition was prepared by blending 1.0 wt. % of Baytron® P and 5.0% wt. % of nanophase antimony tin oxide (ATO) powder (source: Nanophase Technologies), based on solids, with an uncatalyzed aqueous melamine formaldehyde resin using high shear mixing to ensure a complete and evenly dispersed mixture. The ICP composition was then used to impregnate a sheet of transparent overlay material using similar methods described in Example 2. A sample laminate was prepared with identical core materials and decorative surface sheets used in Examples 1 and 2 with the polyethylene dioxythiophene/antimony tin oxide modified melamine formaldehyde resin treated transparent overlay sheet comprising the outermost or surface layer of the laminate, denoted EX-3.

The sample laminate of Example 3 hereinabove denoted EX-3 was mounted on ⅝″ furniture grade plywood, isolated from ground, and tested for point-to-point resistance (Rₜₜ), and electrostatic charge dissipation. Results of the electrical testing performed on EX-3 are setforth in Table 3.

TABLE 3

| | | Resistance | | |
|---|---|---|---|---|
| | Relative | (Point- | Charge Dissipation - Residual | |
| Laminate | Humidity | to-Point)* | Charge on Disk (Volts) | |
| ID | Level | (Ohms) | +1000 V | −1000 V |
| EX-3 | 50% RH | 2.42 × 10⁶ | 9 | −8 |
| | 10% RH | 2.35 × 10⁶ | 41 | −33 |

*Measurements taken at a distance of 3″ due to size of test sample.

The results of the electrical testing showed that the polyethylene dioxythiophene/antimony tin oxide modified melamine formaldehyde resin proved to be an effective resin composition for the preparation of an electrostatic charge dissipating laminate.

### EXAMPLE 4

A third inherently conductive polymer composition was prepared by synthesizing melamine formaldehyde resin prepolymer in the presence of polyethylene dioxythiophene dispersed in water. The synthesis was conducted in a 5-neck reaction flask using the following:

Components

307 parts Baytron® P

126 parts Melamine solids

45 parts Formaldehyde solution (in water)

Overall pH of the reaction system was adjusted to 9.1-9.3 by means of caustic soda ash. The reaction mixture was slowly heated to approximately 90° C. and maintained at this temperature for 45-90 minutes. The reaction was considered complete at a water tolerance level of 150. Upon completion, the reaction vessel the reaction vessel was cooled to 110-120° F. and distilled under vacuum to increase the solids content of the resulting M/F resin. Total solids content of the PEDOT M/F resin was determined to be approximately 47%. Final pH of the resin was adjusted above 10 using caustic soda ash.

The PEDOT M/F resin of the present example was then used to impregnate a sheet of transparent overlay material and dried. A single dip and squeeze process was required to achieve a resin content of approximately 58% due to the increased M/F solids compared to the resin compositions of Examples 2 and 3.

Two sample laminates were prepared with identical core materials and decorative surface sheets used in Example 3 with a PEDOT M/F resin treated transparent overlay sheet comprising the outermost or surface layer of each laminate, denoted EX-4A and EX-4B.

The sample laminates hereinabove denoted EX-4A and EX-4B were mounted onto ⅝″ furniture grade plywood, isolated from ground, and tested for point-to-point resistance (Rₜₜ), and electrostatic charge dissipation. Results of the electrical testing performed on EX-4A and EX-4B are presented in Table 4.

TABLE 4

| | | Resistance | | |
|---|---|---|---|---|
| | Relative | (Point- | Charge Dissipation - Residual | |
| Laminate | Humidity | to-Point)* | Charge on Disk (Volts) | |
| ID | Level | (Ohms) | +1000 V | −1000 V |
| EX-4A | 50% RH | 2.50 × 10⁶ | 45 | −2 |
| | 10% RH | 2.52 × 10⁶ | −2 | 13 |
| EX-4B | 50% RH | 2.06 × 10⁶ | 37 | −29 |
| | 10% RH | 1.65 × 10⁶ | 56 | −28 |

*Measurements taken at a distance of 3″ due to size of test sample.

The results of the point-to-point resistance and charge dissipation testing clearly show the feasibility of synthesizing melamine formaldehyde resins in the presence of PEDOT for the purpose of preparing an electrostatic charge dissipating laminate. In addition, the point-to-point resistance measurements and charge dissipation test results clearly demonstrate the ability of the laminates to effectively meet the requirements of ESD S4.1-1997 and ANSI/ESD STM4.2-1998 at relative humidities as low as 10%.

### EXAMPLE 5

Three sample laminates were prepared from an electrostatic charge dissipating resin based on nanophase antimony tin oxide materials. The resin composition consisted of 10.0% nanophase antimony tin oxide solids (source: Ishihara Corporation) based on total melamine formaldehyde resin solids. Approximately 52 g of Ishihara Corporation's antimony tin oxide dispersion in water was added to 300 g of 1.0 wt. % p-toluene sulfonic acid (source: Capital Resin Corporation, CRC-636) catalyzed, melamine formaldehyde resin. The catalyzed M/F resin and ATO dispersion were mixed using high shear mixing to ensure a complete and evenly dispersed mixture. The ATO modified M/F resin composition was then used to impregnate a cellulose-based decorative surface paper in the usual way and dried. The total resin content of the resin treated decorative surface sheets was about 50%.

Prior to treatment with the ATO modified M/F resin, the decorative surface sheets were pretreated with a 5.0 wt. % antimony tin oxide dispersion in water using similar dip and squeeze treatment techniques used for the application of the M/F resin composition. Following application of the ATO dispersion the decorative surface sheets were dried for 2½ minutes at 120° C.

Three sample laminates were prepared using the ATO modified M/F treated decorative surface sheets as the outermost layer. The laminate cores were comprised of four sheets of phenolic treated Kraft paper sandwiched between 2 beige phenolic treated barrier sheets. Two of the three laminates, denoted EX-5A and EX-5B, also contained a conductive non-woven carbon mat or scrim (source: Hollingsworth and Vose Company) placed between the beige barrier sheet and first phenolic treated Kraft paper used in the core. The conductive non-woven carbon mat was approximately 4.5 mils in thickness at a basis weight of 10.0 g/m² and possessed a measured surface resistivity of 5.5 ohms/square. The sample laminates were cured in a multi-opening press at 270-280° F. under a pressure of 450-500 psi.

The sample laminates hereinabove denoted EX-5A, EX-5B and EX-5C were mounted onto ⅝″ furniture grade plywood, isolated from ground, and tested for point-to-point resistance (Rₜₜ), and electrostatic charge dissipation. Results of the electrical testing performed on sample laminates of Example 5 are presented in Table 5.

TABLE 5

| | Relative | Resistance | Charge Dissipation - Residual | |
|---|---|---|---|---|
| Laminate | Humidity | (Point-to-Point) | Charge on Disk (Volts) | |
| ID | Level | (Ohms) | +1000 V | −1000 V |
| EX-5A | 50% RH | 4.35 × 10⁵ | 11 | −13 |
| (scrim) | 10% RH | 2.73 × 10⁵ | 149 | −155 |
| EX-5B | 50% RH | 4.14 × 10⁵ | 15 | −18 |
| (scrim) | 10% RH | 3.24 × 10⁵ | 34 | −16 |
| EX-5C | 50% RH | 1.40 × 10⁸ | 32 | −11 |
| | 10% RH | 1.12 × 10⁸ | 47 | −16 |

Based on the data presented in Table 5, it is apparent that all three laminates effectively dissipate electrostatic charge from their surface even at a relative humidity level of 10%. However, the incorporation of the conductive scrim material into the core of the laminate resulted in a reduction of the point-to-point resistance outside the range of static dissipative materials. In other words, laminates EX-5A and EX-5B are too conductive to meet the requirements of a static dissipative laminate. If a conductive scrim is employed, one may be able to achieve static dissipative properties in a laminate by using lower concentrations of conductive nanophase materials for the paper treatment, the resin treatment, or both.

### EXAMPLE 6

A series of static dissipative hard surface laminates were prepared by impregnating a cellulose-based decorative surface paper with aqueous dispersions of ATO followed by treatment with a conventional, unmodified melamine formaldehyde resin. Four different ATO dispersion concentrations were employed and included: 2.5, 5.0, 7.5, and 10.0 wt. % ATO. The decorative surface paper was impregnated with the various ATO dispersions using a dip and squeeze treatment technique and subsequently dried for 1.5 to 3 minutes at 120-150° C. prior to application of the unmodified melamine formaldehyde resin. The effective application rate of the dispersions fell within the range of 0.005 g/cm² to 0.25 g/cm². Unmodified melamine formaldehyde resin, containing 1.0% toluene sulfonic acid catalyst, was impregnated into the decorative surface paper using the same dip and squeeze treatment technique and subsequently dried for 2-3 minutes at 120-150° C. The resulting decorative surface paper contained a total resin content of approximately 54% based on weight.

A total of eight different laminates were prepared, two of each ATO concentration, using a symmetrical laminate buildup. Each laminate consisted of an ATO modified decorative surface sheet, four phenol-formaldehyde impregnated Kraft papers, and a conventional melamine formaldehyde treated decorative surface sheet to balance the backside of the laminate. Four of the laminates, one of each ATO concentration, also contained a melamine formaldehyde treated conductive scrim layer, placed immediately beneath the ATO modified decorative surface sheet.

The laminates were pressed at 270-280° F. under a pressure of 1100-1400 psi in a multi-opening press for about 45-60 minutes. The laminates were then mounted to ⅝″ plywood using contact adhesive and wood screws. Laminates of the current example were designated EX-6A (2.5 wt. % ATO), EX-6B (2.5 wt. % ATO, with scrim), EX-6C (5.0 wt. % ATO), EX-6D (5.0 wt. % ATO, with scrim), EX-6E (7.5 wt. % ATO), EX-6F (7.5 wt. % ATO, with scrim), EX-6G (10.0 wt. % ATO) and EX-6H (10.0 wt. % ATO, with scrim). The laminates were subsequently tested for surface resistance (point-to-point, Rₜₜ) and electrostatic charge dissipation at 20% RH. The results of the electrical testing are summarized in Table 6.

TABLE 6

| | Relative | Resistance | Charge Dissipation - Residual | |
|---|---|---|---|---|
| Laminate | Humidity | (Point-to-Point) | Charge on Disk (Volts) | |
| ID | Level | (Ohms) | +1000 V | −1000 V |
| EX-6A | 20% RH | 7.74 × 10⁹ | 645 | −742 |
| EX-6B | 20% RH | 2.91 × 10⁹ | 987 | −995 |
| (scrim) | | | | |
| EX-6C | 20% RH | 1.05 × 10⁸ | 11 | 0 |
| EX-6D | 20% RH | 2.21 × 10⁸ | 58 | 0 |
| (scrim | | | | |
| EX-6E | 20% RH | 2.24 × 10⁷ | 5 | 0 |
| EX-6F | 20% RH | 5.40 × 10⁷ | 12 | 0 |
| (scrim) | | | | |
| EX-6G | 20% RH | 1.16 × 10⁷ | 77 | −76 |
| EX-6H | 20% RH | 5.78 × 10⁷ | 11 | 7 |
| (scrim) | | | | |

The measured point-to-point resistance values of the laminates prepared in this example ranged from 10⁷ to 10⁹ ohms, with only EX-6A and EX-6B (2.5 wt. % ATO treatment) not meeting the resistance criteria specified in ESD S4.1 at 20% RH. A similar trend was found for the charge dissipation test results, as well. All laminates, except EX-6A and EX-6B adequately dissipated electrostatic charge in accordance with ANSI/ESD STM4.2-1998.

### EXAMPLE 7

A static dissipative laminate according to the present invention was made by applying Baytron® P directly to the surface of transparent overlay material previously treated with melamine formaldehyde resin. The transparent overlay material was treated with 1% p-toluene sulfonic acid catalyzed melamine formaldehyde resin and dried using techniques commonly employed in the industry. The total resin content of the transparent overlay material was approximately 47-52%.

A composition of Baytron® P was prepared by diluting the initial concentration of polyethylene dioxythiophene down to approximately 0.65 wt. % solids by the addition of distilled water under constant agitation. The diluted Baytron® P dispersion was then applied directly to the surface of the transparent overlay previously treated with M/F resin using a simple dip and squeeze process. Following application of the Baytron® P dispersion, the transparent overlay material was dried for approximately 2-3 minutes at 120-150° C.

A sample laminate, denoted EX-7, was prepared in a manner consistent with that described in Example 2, with the Baytron® P modified transparent overlay material used as the outermost or surface layer of the laminate. The sample laminate hereinabove denoted EX-7 was mounted onto ⅝″ furniture grade plywood, isolated from ground, and tested for point-to-point resistance (Rₜₜ), and electrostatic charge dissipation. Results of the electrical testing performed on sample laminate EX-7 are presented in Table 7, below.

TABLE 7

| | Relative | Resistance | Charge Dissipation - Residual | |
|---|---|---|---|---|
| Laminate | Humidity | (Point-to-Point) | Charge on Disk (Volts) | |
| ID | Level | (Ohms) | +1000 V | −1000 V |
| EX-7 | 50% RH | 3.46 × 10⁶ | 153 | −17 |
| | 10% RH | 2.73 × 10⁶ | 98 | −22 |

The results of the electrical testing showed that sample laminate EX-7 possessed a point-to-point resistance in the static dissipative range of 10^{6 to} 10⁹ ohms at 50% and 10% relative humidity. In addition, sample laminate EX-7 also effectively dissipated electrostatic charge in accordance with ANSI/ESD STM4.2-1998 at both relative humidities tested.

### EXAMPLE 8

A series of four laminates were prepared using the methodology described in Example 7, namely the direct application of the inherently conductive polymer, polyethylene dioxythiophene, to the surface of transparent overlay material previously treated with melamine formaldehyde resin. The application of Baytron® P to the treated transparent overlay material was effected using an aerosol spray system. Three different coverage amounts of the Baytron P dispersion (at 1.3 wt. % solids) were employed. The coverage amounts corresponded to a range of material application, light (0.0025 g/cm² to 0.0075 g/cm²), medium (0.0075 g/cm² to 0.0125 g/cm²), and heavy (0.0125 g/cm² to 0.0175 g/cm²) coverage. Following application of the ICP dispersion onto the surface of the M/F resin treated transparent overlay material the surface sheets were dried at approximately 120° C. for 2-3 minutes.

The ICP treated trans overlays were then used to prepare sample laminates for testing and evaluation by combining the surface sheets with core materials similar to those described in Example 2, with and without the addition of a conductive non-woven carbon mat or scrim (source: Hollingsworth and Vose Company), as described in Example 5, placed at various positions within the core of the laminate. A conductive scrim layer was positioned directly behind the top phenolic treated beige barrier sheet (position #1, EX-8B), in the center of the laminate between the second and third phenolic treated Kraft core layer (position #2, EX-8C), and directly before the bottom beige phenolic treated barrier sheet (position #3, EX-8D). All sample laminates of Example 8 were cured in a multi-opening press at 270-280° F. under a pressure of 450-500 psi for approximately 45-60 minutes. The sample laminates of Example 8 were denoted EX-8A (no scrim), EX-8B-2, EX-8B-3 and EX-8C-1. The letter A, B and C correspond to light, medium and heavy application coverage of the 1.3 wt. % Baytron P material, respectively, while the numbers 1, 2 and 3 refer to the position of the conductive scrim material in the core of the laminate. A sample with no number designation refers to a sample laminate that did not include a conductive scrim layer in the core.

The sample laminates hereinabove denoted EX-8A, EX-8B-2, EX-8B-3 and EX-8C-1 were mounted onto ⅝′ furniture grade plywood, isolated from ground, and tested for point-to-point resistance (R^{tt}), and electrostatic charge dissipation. Results of the electrical testing performed on the sample laminates of Example 8 are set forth in Table 8, below.

TABLE 8

| | | Resistance | | |
|---|---|---|---|---|
| | Relative | (Point- | Charge Dissipation - Residual | |
| Laminate | Humidity | to-Point)* | Charge on Disk (Volts) | |
| ID | Level | (Ohms) | +1000 V | −1000 V |
| EX-8A | 50% RH | 1.23 × 10⁸* | 90 | −32 |
| | 20% RH | 5.03 × 10⁸* | 65 | −20 |
| EX-8B-2 | 50% RH | 9.85 × 10⁴** | 142 | −44 |
| | 20% RH | 1.67 × 10⁵** | 66 | −4 |
| EX-8B-3 | 50% RH | 2.80 × 10⁶* | 28 | −7 |
| | 20% RH | 2.70 × 10⁶* | 78 | −6 |
| EX-7C-1 | 50% RH | 1.96 × 10⁴** | 42 | 0 |
| | 20% RH | 2.04 × 10⁴** | 61 | −8 |

*Measurements taken at a distance of 3″ due to size of test sample.
**Measurement taken at an applied potential of 10 V.

As can be seen from the data presented in Table 8, all four sample laminates prepared in Example 8 passed the charge dissipation requirements set forth in ANSI/ESD STM4.2-1998 at a relative humidity of 20%. In general, incorporation of a conductive scrim layer did not increase the probability of the laminate meeting the charge dissipation requirements, however it did appear to affect the point-to-point resistance of the laminate, lowering R^{tt} outside the static dissipative range of 10^{6 to} 10⁹ ohms. Only sample laminate EX-8A possessed a point-to-point resistance in the static dissipative range and met the charge dissipation requirements outlined in ANSI-ESD STM4.2-1998.

### EXAMPLE 9

A series of antimony tin oxide based laminates were prepared using the same application technique described in Example 8. A 2.0 wt. % antimony tin oxide dispersion was prepared by slowly adding 6 g of nanophase antimony tin oxide powder (source: Nanophase Technologies) into 300 g of distilled, deionized water subjected to high shear forces. High shear mixing continued for approximately 15-20 minutes after the entire amount of ATO powder had been added. The dispersion appeared relatively stable with no signs of precipitation after a period of 20 minutes.

The aforementioned antimony tin oxide dispersion was then applied directly to the surface of a decorative surface sheet previously treated with M/F resin and dried. Application of the ATO dispersion was effected using a simple aerosol spray system as described in Example 8.

Two different coverage amounts were used with two laminates from each coverage amount prepared, denoted EX-9A-1, EX-9A-2, EX-9B-1 and EX-9B-2. Sample laminates EX9A-1 and EX-9A-2 correspond to an ATO dispersion application rate of 0.012 g/cm² to 0.020 g/cm², while sample laminates EX-9B-1 and EX-9B-2 correspond to an ATO dispersion application rate of 0.020 g/cm² to 0.028 g/cm².

The ATO treated decorative surface sheets were then used to prepare sample laminates for testing and evaluation by combining the surface sheets with core materials similar to those described in Example 2. All four sample laminates were cured in a multi-opening press at 270-280° F. under a pressure of 450-500 psi for approximately 45-60 minutes.

The sample laminates hereinabove denoted EX-9A-1, EX-9A-2, EX-9B-1 and EX-9B-2 were mounted onto ⅝″ furniture grade plywood, isolated from ground, and tested for point-to-point point resistance (Rₜₜ), and electrostatic charge dissipation at 50% and 20% relative humidity. Results of the electrical testing performed on the sample laminates of Example 9 are presented in Table 9.

TABLE 9

| | | Resistance | | |
|---|---|---|---|---|
| | Relative | (Point- | Charge Dissipation - Residual | |
| Laminate | Humidity | to-Point)* | Charge on Disk (Volts) | |
| ID | Level | (Ohms) | +1000 V | −1000 V |
| EX-9A-1 | 50% RH | 6.18 × 10⁸ | 25 | −35 |
| | 20% RH | 5.58 × 10⁹ | 55 | −43 |
| EX-9A-2 | 50% RH | 7.83 × 10⁸ | 13 | −74 |
| | 20% RH | 7.12 × 10⁹ | 4 | −4 |
| EX-9B-1 | 50% RH | 3.20 × 10⁸ | 13 | −66 |
| | 20% RH | 5.99 × 10⁹ | 25 | −59 |
| EX-9B-2 | 50% RH | 1.01 × 10⁸ | 12 | −4 |
| | 20% RH | 2.89 × 10⁹ | 1 | 1 |

*Measurements taken at a distance of 3″ due to size of test sample.

As can be seen from Table 9, all four laminates possessed a point-to-point resistance in the static dissipative range of 10^{6 to} 10⁹ ohms at both relative humidity levels tested.

Results of the charge dissipation test were very positive, as well, with all four sample laminates of Example 9 meeting the requirement of less than |200 V| remaining on the aluminum charge plate following a contact time of 5 seconds. It appears from these results that the antimony tin oxide modified surface is highly effective at dissipating charge from the surface of the laminate.

In addition, the use of antimony tin oxide results in a slight grayish blue hue in the laminate, which enables an aesthetically pleasing laminate surface to be prepared.

The above-referenced patents, publications and test methods are hereby incorporated in their entirety.

Many variations of the present invention will suggest themselves to those skilled in the art in light of the above-detailed description. All such obvious modifications are within the full-intended scope of the appended claims.

1. An electrostatic dissipating laminate structure comprising:
(a) a cellulose-based substrate;
(b) a conductance-modifying component selected from the group consisting of an inherently conductive polymer, a conductive nanophase material and mixtures thereof; and
(c) a thermosetting polymer resin.

2. The laminate structure of claim 1 wherein said thermosetting polymer resin is selected from the group consisting of unsaturated polyesters, polyurethanes, polyureas, epoxies, bismaleimides and formaldehyde-type thermosetting resin compositions.

3. The laminate structure of claim 1 wherein said cellulose-based substrate is pretreated with a conductance modifying component selected from the group consisting of an inherently conductive polymer, a conductive nanophase material and a combination of an inherently conductive polymer and a conductive nanophase material.

4. The laminate structure of claim 3 wherein said cellulose-based substrate is pretreated with a colloidal dispersion of an inherently conductive polymer in an aqueous medium at a concentration ranging from about 0.1% to about 20.0% by weight.

5. The laminate structure of claim 3 wherein said cellulose-based substrate is pretreated with a colloidal dispersion of a conductive nanophase material in an aqueous medium at concentrations ranging from about 1.0% to about 25.0% by weight.

6. The laminate structure of claim 1 further comprising a transparent overlay sheet, a decorative under sheet or both.

7. The laminate structure of claim 6 further comprising at least one internal layer comprising a cellulose-based sheet saturated with a thermosetting polymer resin.

8. The laminate structure of claim 7 further comprising at least one layer comprising a heavy paper saturated with a phenol formaldehyde resin.

9. The laminate structure of claim 1 further comprising a conductive scrim layer.

10. The laminate structure of claim 9 wherein said conductive scrim layer comprises a conductance-modifying component selected from the group consisting of an inherently conductive polymer, a conductive nanophase material and a combination of an inherently conductive polymer and a conductive nanophase material.

11. The laminate structure of claim 9 wherein said conductive scrim layer comprises a conductive non-woven material incorporated into said laminate beneath a cellulose-based sheet impregnated with a dissipative polymer composition.

12. The laminate structure of claim 2 wherein said thermosetting polymer resin comprises melamine formaldehyde.

13. The laminate structure of claim 1 wherein said conductance-modifying component comprises an inherently conductive polymer.

14. The laminate structure of claim 13 wherein said inherently conductive polymer comprises polyethylene dioxythiophene polystyrene sulfonate.

15. The laminate structure of claim 13 wherein said inherently conductive polymer comprises polyaniline.

16. The laminate structure of claim 13 wherein said dissipative polymer composition comprises an amount of said inherently conductive polymer between less than 1.0% and approximately 15% of the weight of said thermosetting polymer resin present in said structure.

17. The laminate structure of claim 1 wherein said conductance-modifying component comprises at least one conductive nanophase material.

18. The laminate structure of claim 17 wherein said dissipative polymer composition comprises nanophase materials in an amount between less than 1% and approximately 25% by weight of said thermosetting polymer resin present in said composition.

19. The laminate structure of claim 17 wherein said conductive nanophase materials comprise antimony tin oxide.

20. An improved method of forming an electrostatic dissipating hard laminate structure wherein a cellulose-based structure is impregnated with a thermosetting polymer resin, said improvement comprising imparting electrostatic dissipating properties to said laminate structure wherein the improvement comprises adding a conductance modifying component selected from the group consisting of an inherently conductive polymer, a conductive nanophase material and mixtures thereof to said laminate structure by (i) impregnating said polymer resin with said conductance modifying component; or (ii) forming an aqueous dispersion of said conductance modifying component and applying said aqueous dispersion to said hard laminate structure. 21. An improved method as defined in claim 20 wherein said application of said aqueous dispersion to said hard laminate structure comprises aerosol spraying. 22. An improved method as defined in claim 20 wherein said application of said aqueous dispersion to said hard laminate structure comprises applying said aqueous dispersion to a transfer coating and then applying said transfer coating to said hard laminate structure.
